(19) United States
(12) Patent Application Publication
(10) Pub. No.: US 2013/0114886 A1
(43) Pub. Date: May 9, 2013

(54) POSITION AND ORIENTATION MEASUREMENT APPARATUS, POSITION AND ORIENTATION MEASUREMENT METHOD, AND STORAGE MEDIUM

(71) Applicants: Daisuke Kotake, Yokohama-shi (JP); Shinji Uchiyama, Yokohama-shi (JP)

(72) Inventors: Daisuke Kotake, Yokohama-shi (JP); Shinji Uchiyama, Yokohama-shi (JP)

(73) Assignee: CANON KABUSHIKI KAISHA, Tokyo (JP)

(21) Appl. No.: 13/810,731

(22) PCT Filed: Jul. 21, 2011
(86) PCT No.: PCT/JP2011/067178

§ 371 Date: Jan. 17, 2013

(30) Foreign Application Priority Data
Jul. 23, 2010 (JP) 2010-166500

(51) Int. Cl. G06K 9/00

(52) U.S. Cl. CPC G06K 9/00
USPC 382/154

(57) ABSTRACT

A position and orientation measurement apparatus for measuring a position and orientation of a target object, comprising: storage means for storing a three-dimensional model representing three-dimensional shape information of the target object; obtaining means for obtaining a plurality of measurement data about the target object sensed by image sensing means; reliability calculation means for calculating reliability for each of the pieces of measurement data; selection means for selecting the measurement data by a predetermined number from the plurality of measurement data based on the reliability; association means for associating planes forming the three-dimensional model with each of the measurement data selected by the selection means; and decision means for deciding the position and orientation of the target object based on the result associated by the association means.

### TECHNICAL FIELD

The present invention relates to a position and orientation measurement apparatus and a position and orientation measurement method using known three-dimensional shape information, and a storage medium.

### BACKGROUND ART

With recent development in robot technology, robots are replacing humans to carry out complicated tasks such as assembling industrial products. Such a robot assembles components by gripping them with an end effector such as a hand. Gripping a component by the robot requires measuring the position and orientation relationship between the component to be gripped and the robot (hand). Measurement of the position and orientation is applied not only to component gripping by the robot but also to various purposes, including self-position estimation of the robot for autonomous movement and alignment of a virtual object in a physical space (physical object) in augmented reality.

An example of a method for measuring the position and orientation uses a two-dimensional image obtained from an image sensing device such as a camera or a distance image obtained from a distance sensor. T. Drummond and R. Cipolla, “Real-time visual tracking of complex structures,” IEEE Transactions on Pattern Analysis and Machine Intelligence, vol. 24, no. 7, pp. 932-946, 2002 mentions a method of measuring the position and orientation of an object by representing a three-dimensional model for an object by a set of line segments and fitting the projected image of the three-dimensional model to edges serving as features on a two-dimensional image.

According to this method, line segments in the three-dimensional model are projected onto a two-dimensional image based on an approximate position and orientation given as known information. The two-dimensional image is searched for edges that correspond to respective control points discretely arranged on the projected line segments. The approximate position and orientation are corrected to minimize the sum of squares of the distances on the image between the projected images of line segments containing the control points and corresponding edges, based on the obtained correspondence between the model (control points) and the edges. Accordingly, a final position and orientation are obtained. Also, D. A. Simon, M. Hebert, and T. Kanade, “Real-time 3-D pose estimation using a high-speed range sensor,” Proc. 1994 IEEE International Conference on Robotics and Automation (ICRA '94), pp. 2235-2241, 1994 describes a method of measuring the position and orientation of an object by fitting a three-dimensional model (polygon model) for the object to a three-dimensional point cloud on an object surface obtained by converting a distance image. This method is premised on that an approximate position and orientation are given as known information, similar to the method described in T. Drummond and R. Cipolla, “Real-time visual tracking of complex structures,” IEEE Transactions on Pattern Analysis and Machine Intelligence, vol. 24, no. 7, pp. 932-946, 2002. The polygon model is translated and rotated based on the approximate position and orientation to associate each point out in the point cloud with the nearest polygon. The approximate position and orientation are corrected to minimize the sum of squares of the three-dimensional distances in a three-dimensional space between associated polygons and measurement points, thereby obtaining a final position and orientation. In the method of fitting a model to measurement data, a larger number of measurement data lessen the influence of a measurement error contained in individual measurement data. Using many measurement data is expected to improve the measurement accuracy.

Work such as assembly of industrial products is expected to speed up by using robots. For quick robot work, it is necessary to speed up the robot operation and also quickly measure the position and orientation relationship between the robot and work target required to determine the operation. Using the robot is expected to achieve more precise work, so high accuracy is requested in addition to high position and orientation measurement speed. In the above method of fitting a three-dimensional model, the position and orientation of a component are expected to be measured with high accuracy using many measurement data. However, using many measurement data prolongs the calculation time, and it is demanded to measure the position and orientation with high accuracy from a minimum number of measurement data.

A simplest method of extracting measurement data by a necessary number from many measurement data is equal-interval sampling. However, the equal-interval sampling sometimes cannot uniquely determine the position and orientation depending on a combination of measurement data to be sampled. To solve this problem, N. Gelfand, L. Ikemoto, S. Rusinkiewicz, and M. Levoy, “Geometrically stable sampling for the ICP algorithm,” Proc. 4th International Conference on 3-D Digital Imaging and Modeling (3DIM 2003), pp. 260-267, 2003 describes a method of determining, from sampled measurement data, the degree of freedom for which measurement data are insufficient for determination of position and orientation, and preferentially sampling measurement data necessary to determine the degree of freedom. However, this method determines measurement data to be sampled from only correspondence information between measurement data and a model without taking account of the quality of measurement data itself such as a measurement error. When calculating the position and orientation from a small number of measurement data, individual measurement data has a great influence. Any poor-quality measurement data may cause a problem such as poor measurement accuracy or in some cases, calculation divergence.

The present invention provides a technique of measuring the position and orientation of an object quickly with high accuracy by sampling measurement data based on their qualities.

### SUMMARY OF INVENTION

According to one aspect of the present invention, there is provided a position and orientation measurement apparatus for measuring a position and orientation of a target object, comprising: storage means for storing a three-dimensional model representing three-dimensional shape information of the target object; obtaining means for obtaining a plurality of measurement data about the target object sensed by image sensing means; reliability calculation means for calculating reliability for each of the measurement data; selection means for selecting the measurement data by a predetermined number from the plurality of measurement data based on the reliability; association means for associating planes forming the three-dimensional model with each of the measurement data selected by the selection means; and decision means for deciding the position and orientation of the target object based on the result associated by the association means.

According to another aspect of the present invention, there is provided a position and orientation measurement method for measuring a position and orientation of a target object, comprising: an obtaining step of obtaining a plurality of measurement data about the target object sensed in an image sensing means; a reliability calculation step of calculating reliability for each of the measurement data; a selection step of selecting the measurement data by a predetermined number from the plurality of measurement data based on the reliability; an association step of associating planes forming a three-dimensional model with each of the measurement data selected in the selection step, based on the three-dimensional model which is stored in storage means and represents three-dimensional shape information; and a decision step of deciding the position and orientation of the target object based on the result associated in the association step.

Further features of the present invention will be apparent from the following description of exemplary embodiments with reference to the attached drawings.

### BRIEF DESCRIPTION OF DRAWINGS

FIG. 1A is a block diagram showing the hardware configuration of a position and orientation measurement apparatus 100 according to the first embodiment;

FIG. 1B is a block diagram showing the arrangement of each processing unit of the position and orientation measurement apparatus 100 according to the first embodiment;

FIGS. 2A to 2D are views for explaining a three-dimensional shape model according to the first embodiment;

FIG. 3 is a flowchart showing a position and orientation measurement processing sequence according to the first embodiment;

FIG. 4 is a flowchart showing a measurement data selection processing sequence according to the first embodiment;

FIG. 5 is a block diagram showing the arrangement of a position and orientation measurement apparatus according to the second embodiment;

FIG. 6 is a flowchart showing a position and orientation measurement processing sequence according to the second embodiment; and

FIG. 7 is a flowchart showing a position and orientation update processing sequence according to the second embodiment.

### DESCRIPTION OF EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

The first embodiment is directed to a position and orientation measurement apparatus which measures the position and orientation of a target object whose three-dimensional shape information has been known as a three-dimensional model. The first embodiment explains an application of a measurement data sampling method according to the embodiment when fitting a three-dimensional model for an object to a three-dimensional point cloud in a three-dimensional coordinate system obtained by converting a distance image measured by a distance sensor. Note that the position and orientation are measured after selecting all necessary data.

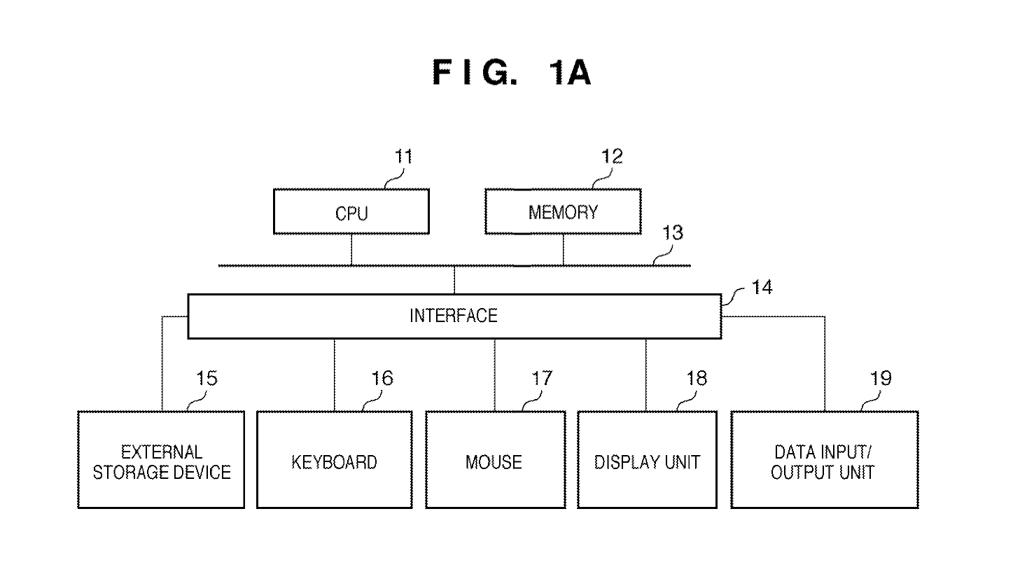

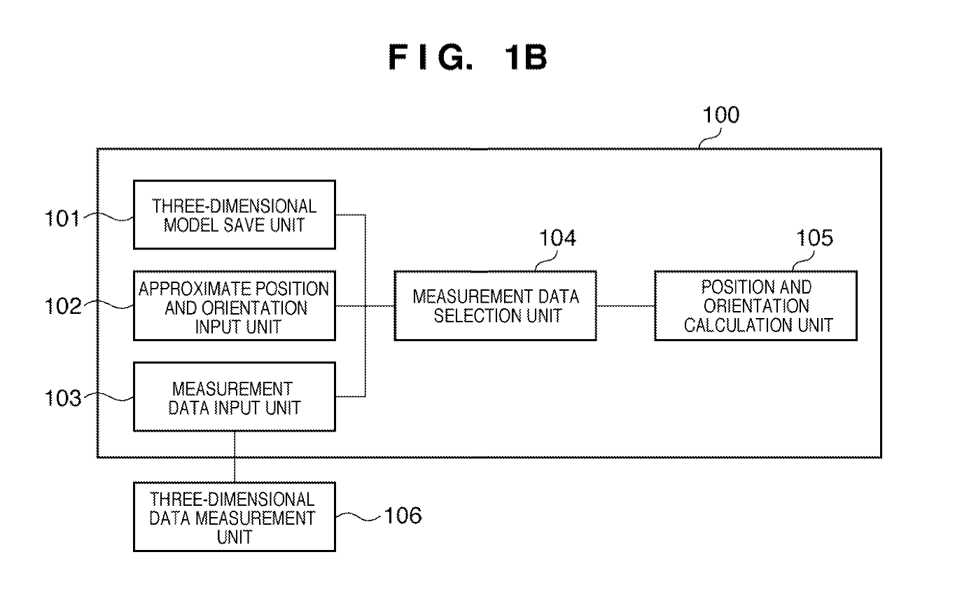

The hardware configuration of the position and orientation measurement apparatus according to the first embodiment will be described with reference to FIG. 1A. A CPU 11 controls the operation of the whole apparatus, more specifically, that of each processing unit to be described later. A memory 12 stores programs and data for use in the operation of the CPU 11. A bus 13 manages data transfer between building modules. An interface 14 interfaces the bus 13 and various devices. An external storage device 15 stores programs and data to be loaded into the CPU 11. A keyboard 16 and mouse 17 build an input device used to activate a program or designate a program operation. A display unit 18 displays the operation result of a program. A data input/output unit 19 inputs/outputs data to/from the outside of the apparatus. A distance image measurement apparatus (not shown) is connected via the data input/output unit 19.

The arrangement of a position and orientation measurement apparatus 100 according to the first embodiment will be described with reference to FIG. 1B. As shown in FIG. 1B, the position and orientation measurement apparatus 100 includes a three-dimensional model save unit 101, approximate position and orientation input unit 102, measurement data input unit 103, measurement data selection unit 104, and position and orientation calculation unit 105. A three-dimensional data measurement unit 106 is connected to the position and orientation measurement apparatus 100. The function of each building unit of the position and orientation measurement apparatus 100 will be explained.

The three-dimensional data measurement unit 106 measures three-dimensional information of a point on an object surface to be measured. In the embodiment, the three-dimensional data measurement unit 106 is, for example, a distance sensor which outputs a distance image as distance information indicating the distance to the object surface. The distance image is an image in which each pixel forming the image has depth information. The embodiment adopts an active distance sensor which senses light of a laser beam emitted to and reflected by a target object with a camera and measures the distance based on the principle of triangulation. However, the distance sensor is not limited to this, and may be of a time-of-flight type using the time of flight of light or of a passive type which calculates the depth of each pixel according to the principle of triangulation based on the correspondence between images sensed by a stereo camera. The type of distance sensor does not impair the gist of the present invention as long as it measures not only distance but also three dimensional data of an object surface. Three-dimensional data measured by the three-dimensional data measurement unit 106 is input to the position and orientation measurement apparatus 100 via the measurement data input unit 103.

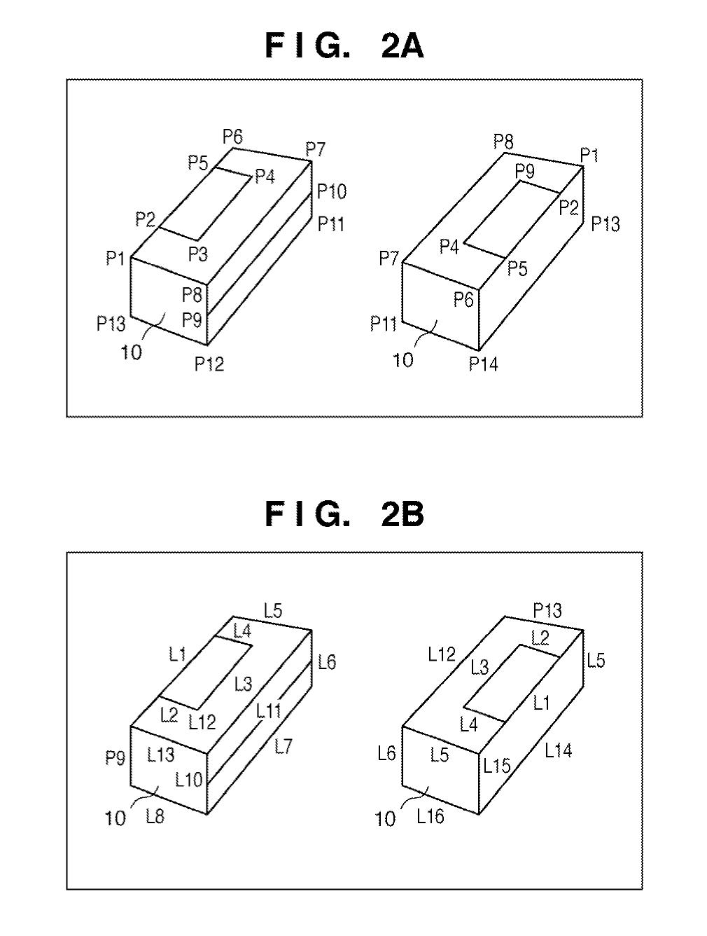

The three-dimensional model save unit 101 saves the three-dimensional model of a measurement target object whose position and orientation are to be measured. In the embodiment, an object is described as a three-dimensional model defined by line segments and planes. FIGS. 2A to 2D are views for explaining a three-dimensional model according to the first embodiment. The three-dimensional model is defined by a set of points and a set of line segments formed by connecting points. A three-dimensional model for a measurement target object 20 is defined by a total of 14 points P1 to P14, as shown in FIG. 2A. Also, the three-dimensional model for the measurement target object 20 is defined by line segments L1 to L16, as shown in FIG. 2B. Each of the points P1 to P14 has three-dimensional coordinates, as shown in FIG. 2C. Each of the line segments L1 to L16 is represented by the IDs of points which form the line segment, as shown in FIG. 2D. For example, the line segment L1 is represented by the points P1 and P6 serving as point IDs. Further, the three-dimensional model stores plane information. Each plane is represented by the IDs of points which define the plane. For the three-dimensional model shown in FIGS. 2A to 2D, information on six planes which form a rectangular parallelepiped is stored. The three-dimensional model is used to sample measurement data by the measurement data selection unit 104 and to calculate the position and orientation of an object by the position and orientation calculation unit 105.

The approximate position and orientation input unit 102 inputs the approximate values of the position and orientation of an object with respect to the position and orientation measurement apparatus 100. Assume that the position and orientation measurement apparatus 100 defines a three-dimensional coordinate system (reference coordinate system) serving as the reference of position and orientation measurement. The position and orientation of an object with respect to the position and orientation measurement apparatus 100 are those of the object in the reference coordinate system. In the embodiment, a coordinate system in which the optical axis of a camera forming the distance sensor is the z-axis is defined as the reference coordinate system. Also in the embodiment, the position and orientation measurement apparatus 100 uses measurement values in previous measurement (previous time) as an approximate position and orientation in order to perform measurement continuously along the time axis. However, the method of inputting the approximate values of the position and orientation is not limited to this. For example, it is also possible to estimate the change amounts of the position and orientation based on the measurement results of a past position and orientation, and predict the approximate values of a current position and orientation from the past position and orientation and the estimated change amounts. If a rough position and orientation at which an object is placed are known in advance, these values are used as approximate values.

The measurement data input unit 103 converts a depth value stored in each pixel of the distance image into three-dimensional coordinates in the reference coordinate system (three-dimensional coordinate system), and inputs them as each position information of the three-dimensional point cloud to the position and orientation measurement apparatus 100.

The measurement data selection unit 104 samples necessary measurement data out of the three-dimensional point cloud received from the measurement data input unit 103, based on the quality of measurement data or the degree of contribution to position and orientation calculation.

The position and orientation calculation unit 105 measures the position and orientation of the object by fitting a three-dimensional model saved in the three-dimensional model save unit 101 to the measurement data (three-dimensional point cloud) selected by the measurement data selection unit 104.

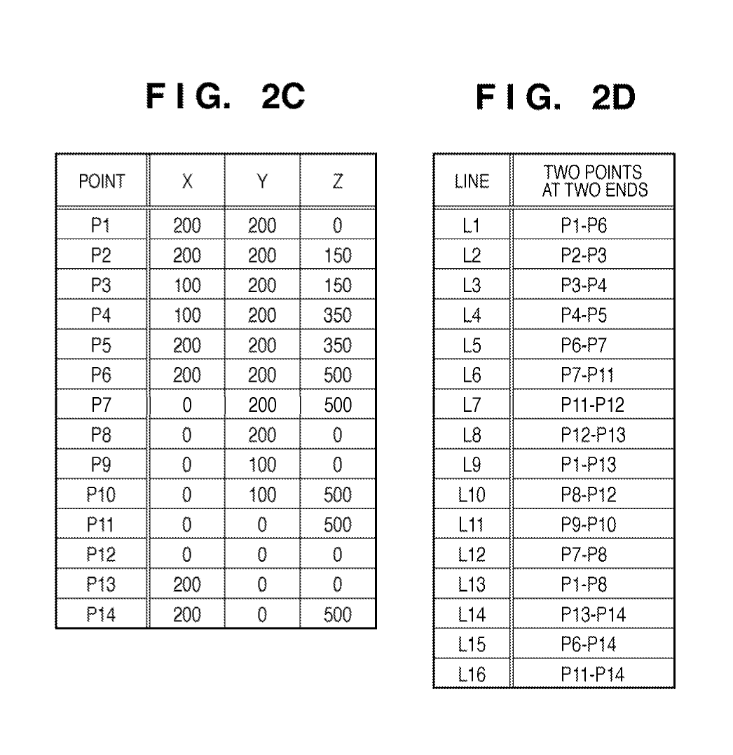

The operation of each processing unit described above will be explained. FIG. 3 is a flowchart showing a position and orientation measurement processing sequence according to the first embodiment. In step S301, the position and orientation measurement apparatus 100 receives, via the approximate position and orientation input unit 102, the approximate values of the position and orientation of an object with respect to the position and orientation measurement apparatus 100. As described above, the embodiment uses measurement values in previous measurement (previous time) as an approximate position and orientation. By using the approximate position and orientation, it could perform a calculation of the position and orientation quickly and it could be expected that an error is reduced in associating the measurement data with the model. However, in the present embodiment, it is not essential to use the approximate position and orientation.

In step S302, measurement data used to calculate the position and orientation of the object are obtained via the measurement data input unit 103. In this case, the measurement data are three-dimensional data of the target object. As described above, the three-dimensional data measurement unit 106 outputs a distance image. The measurement data input unit 103 converts depth information stored in each pixel of the distance image into three-dimensional point cloud data having three-dimensional coordinates in the reference coordinate system, and inputs them to the position and orientation measurement apparatus 100. Conversion from a distance image into a three-dimensional point cloud is achieved by multiplying a view vector corresponding to the pixel position by a depth value.

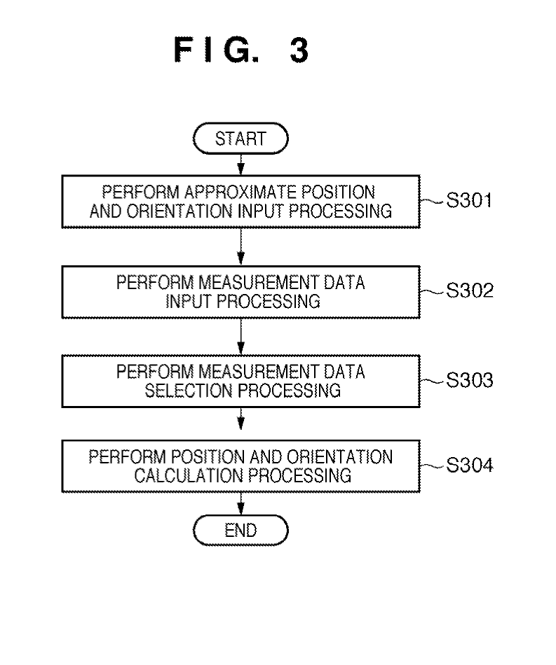

In step S303, measurement data necessary to calculate the position and orientation are selected from the three-dimensional point cloud data input via the measurement data input unit 103. Details of the necessary measurement data selection processing will be described with reference to FIG. 4. FIG. 4 is a flowchart showing a measurement data selection processing sequence.

In step S401, the measurement data selection unit 104 calculates reliability equivalent to the quality of measurement data for each measurement data (reliability calculation processing). The reliability is an index indicating the magnitude of an error contained in position information that arises from a measurement error contained in a measurement data. The embodiment assumes that when measurement points define a locally flat plane and the normal vector of the flat plane correctly faces the distance sensor, measurement can be performed stably. From this, the reliability is determined based on the angle of the normal vector of the flat plane with respect to the position and orientation measurement apparatus. Here, the reliability is calculated based on the z-axis (image sensing direction vector) of the reference coordinate system serving as the optical axis of the camera (image sensing device) and the normal vector of the flat plane. The normal vector of a flat plane near a measurement point is estimated by plane fitting to neighboring points (peripheral points) on the distance image. Both the normal vector obtained by plane fitting and the z-axis of the reference coordinate system are normalized, and the absolute value of the inner product of them is used as the reliability. However, the reliability determination method is not limited to this. For example, for a range sensor using a stereo camera, the reliability may be determined based on a numerical value indicating the degree of patch matching between images (for example, SSD indicating the sum of squares of luminance differences). Any other index may be used as the reliability if it can appropriately express the quality of measurement data.

In step S402, the measurement data selection unit 104 sorts measurement data in descending order of the reliability calculated in step S401. Each measurement data stores a flag Fᵢ (i=1, . . . , N_{D}) indicating whether the measurement data has already been selected. The flag F is initialized to FALSE (indicating that measurement data has not been selected yet). N_{D} is the total number of measurement data.

In step S403, the measurement data selection unit 104 selects a predetermined number of, that is, M measurement data in descending order of reliability from the measurement data sorted in step S402. The measurement data selection unit 104 then changes the flag of the selected measurement data to TRUE (indicating that measurement data has been selected). The M value is the minimum number of measurement data necessary to determine the position and orientation of a measurement target object. For example, M is 6 when calculating the position and orientation based on the correspondence between points and planes. Each of the M selected measurement data is associated with a plane of the three-dimensional model. In the association of measurement data with a plane of the three-dimensional model, the three-dimensional model is translated and rotated based on the approximate position and orientation input in step S301, and a plane of the three-dimensional model that is closest to the measurement data is selected.

In step S404, the measurement data selection unit 104 determines whether the position and orientation can be uniquely determined by the M measurement data selected in step S403. In other words, the measurement data selection unit 104 determines position and orientation components (or the linear sum of them) that cannot be determined by the M selected measurement data in a position and orientation to be determined. This determination is made using a coefficient vector in an equation used to calculate correction values for the position and orientation of an object. The coefficient vector in the equation is obtained by aligning, as components, the partial differential coefficients of the signed distances between points and planes pertaining to the position and orientation. This determination method will be described in detail. For descriptive convenience, assume that the position and orientation are not those of an object in the reference coordinate system but those of a camera in the object coordinate system. The three-dimensional coordinates of the point cloud in the reference coordinate system are converted into three-dimensional coordinates (x, y, z) in the object coordinate system using the above-mentioned position and orientation s (six-dimensional vector indicating the position and orientation). For a given position and orientation s₀, three-dimensional coordinates in the reference coordinate system are converted into three-dimensional coordinates (x₀, y₀, z₀) in the object coordinate system. (x, y, z) is a position and orientation function and can be approximated by first-order Taylor expansions in the neighborhood of (x₀, y₀, z₀) as represented by equations (1):

$$\begin{matrix}\begin{matrix}x \approx {x}_{0} + {\sum }_{i = 1}^{6} \frac{\partial x}{\partial {s}_{i}} Δ {s}_{i} \\ y \approx {y}_{0} + {\sum }_{i = 1}^{6} \frac{\partial y}{\partial {s}_{i}} Δ {s}_{i}\end{matrix} \\ z \approx {z}_{0} + {\sum }_{i = 1}^{6} \frac{\partial z}{\partial {s}_{i}} Δ {s}_{i}\end{matrix} \} \qquad ( 1 )$$

where Δsᵢ (i=1, 2, . . . , 6) is an infinitesimal change in each component of the position and orientation. An equation for a plane associated with a given point in the object coordinate system is defined as ax+by+cz=e (a²+b²+c²=1; a, b, c, and e are constants). Assume that the three-dimensional coordinates (x, y, z) of measurement data (point) in the object coordinate system serving as the reference satisfy the plane equation ax+by+cz=e upon infinitesimally changing the approximate position and orientation. Then, equations (1) and plane equation yield:

$$a {\sum }_{i = 1}^{6} \frac{\partial x}{\partial {s}_{i}} Δ {s}_{i} + b {\sum }_{i = 1}^{6} \frac{\partial y}{\partial {s}_{i}} Δ {s}_{i} + c {\sum }_{i = 1}^{6} \frac{\partial z}{\partial {s}_{i}} Δ {s}_{i} = e - q \qquad ( 2 )$$

where q=ax₀+by₀+cz₀ (constant). Equation (2) represents an infinitesimal change in each component of the position and orientation. Based on M selected points, linear simultaneous equations pertaining to Δsᵢ can be set up like equation (3):

$$[ \begin{matrix}{a}_{1} \frac{\partial x}{\partial {s}_{1}} + {b}_{1} \frac{\partial y}{\partial {s}_{1}} + {c}_{1} \frac{\partial z}{\partial {s}_{1}} & {a}_{1} \frac{\partial x}{\partial {s}_{2}} + {b}_{1} \frac{\partial y}{\partial {s}_{2}} + {c}_{1} \frac{\partial z}{\partial {s}_{2}} & … & {a}_{1} \frac{\partial x}{\partial {s}_{6}} + {b}_{1} \frac{\partial y}{\partial {s}_{6 }} + {c}_{1} \frac{\partial z}{\partial {s}_{6}} \\ {a}_{2} \frac{\partial x}{\partial {s}_{1}} + {b}_{2} \frac{\partial y}{\partial {s}_{1}} + {c}_{2} \frac{\partial z}{\partial {s}_{1}} & {a}_{2} \frac{\partial x}{\partial {s}_{2}} + {b}_{2} \frac{\partial y}{\partial {s}_{2}} + {c}_{2} \frac{\partial z}{\partial {s}_{2}} & … & {a}_{2} \frac{\partial x}{\partial {s}_{6}} + {b}_{2} \frac{\partial y}{\partial {s}_{6}} + {c}_{2} \frac{\partial z}{\partial {s}_{6}} \\ ⋮ & ⋮ & ⋱ & ⋮ \\ {a}_{M} \frac{\partial x}{\partial {s}_{1}} + {b}_{M} \frac{\partial y}{\partial {s}_{1}} + {c}_{M} \frac{\partial z}{\partial {s}_{1}} & {a}_{M} \frac{\partial x}{\partial {s}_{2}} + {b}_{M} \frac{\partial y}{\partial {s}_{2}} + {c}_{M} \frac{\partial z}{\partial {s}_{2}} & … & {a}_{M} \frac{\partial x}{\partial {s}_{6}} + {b}_{M} \frac{\partial y}{\partial {s}_{6}} + {c}_{M} \frac{\partial z}{\partial {s}_{6}}\end{matrix} ] [ \begin{matrix}Δ {s}_{1} \\ Δ {s}_{2} \\ Δ {s}_{3} \\ Δ {s}_{4} \\ Δ {s}_{5} \\ Δ {s}_{6}\end{matrix} ] = [ \begin{matrix}{e}_{1} - {q}_{1} \\ {e}_{2} - {q}_{2} \\ ⋮ \\ {e}_{M} - {q}_{M}\end{matrix} ] \qquad ( 3 )$$

Rewriting equation (3) yields:

JΔs=E (4)

The rank of the matrix J^{T}J determines whether the position and orientation can be uniquely determined by M measurement data, as described in N. Gelfand, L. Ikemoto, S. Rusinkiewicz, and M. Levoy, “Geometrically stable sampling for the ICP algorithm,” Proc. 4th International Conference on 3-D Digital Imaging and Modeling (3DIM 2003), pp. 260-267, 2003. The matrix J^{T}J is expressed by the product of the transpose of a coefficient matrix which defines the positional relationship between three-dimensional points and planes forming a three-dimensional model, and the coefficient matrix. For a rank-deficient matrix J^{T}J, position and orientation components corresponding to an eigenvector with an eigenvalue of 0 in the matrix J^{T}J cannot be uniquely determined. Thus in step S404, the matrix J^{T}J undergoes eigenvalue decomposition, calculating six eigenvectors EVi (i=1, . . . , 6) and corresponding eigenvalues. An information amount Ei (i=1, . . . , 6) used to determine a position and orientation component corresponding to each eigenvector is then stored. In the embodiment, when the value of the information amount Ei is larger than a given threshold Th, the position and orientation can be uniquely determined. The information amount Ei to be stored is the sum of squares of the inner products of the eigenvector EVi and the coefficient vectors (corresponding to a row in the matrix on the left-hand side of equation (3)) of M measurement data, similar to N. Gelfand, L. Ikemoto, S. Rusinkiewicz, and M. Levoy, “Geometrically stable sampling for the ICP algorithm,” Proc. 4th International Conference on 3-D Digital Imaging and Modeling (3DIM 2003), pp. 260-267, 2003. An eigenvector with an eigenvalue of almost 0 yields Evi of almost 0.

More specifically, feature amount calculation processing is performed to calculate a feature amount (information amount Ei (i=1, . . . , 6)) based on eigenvectors and eigenvalues obtained by eigenvalue decomposition of the matrix J^{T}J to indicate whether the position and orientation of a target object can be determined in correspondence with the eigenvectors.

In step S405, the measurement data selection unit 104 determines whether measurement data need to be additionally selected in order to uniquely determine the position and orientation. This determination is made based on whether the above-mentioned information amount Ei is larger than the threshold Th. If Ei is equal to or smaller than the threshold Th (YES in step S405), an information-short component exists and the process advances to step S406. In step S406, the measurement data selection unit 104 additionally selects new measurement data, and the process returns to step S405. Detailed processing in step S406 will be described later. If the measurement data selection unit 104 determines in step S405 that all Ei values are larger than the threshold Th (NO in step S405), no information-short component exists, the data selection processing in step S303 ends, and the process advances to step S304. If there is a plenty of calculation time left, the threshold Th in step S405 is set larger and the data addition processing in step S406 is executed by more times. A larger number of measurement data can be used to improve accuracy. If there is not much calculation time left, the processing speed is increased by decreasing the threshold Th and executing the data addition processing in step S406 by only a minimum number of times.

In step S406, the measurement data selection unit 104 selects measurement data having a coefficient vector close to an eigenvector with a smallest Ei. To do this, the measurement data selection unit 104 determines whether the feature amount (information amount Ei (i=1, . . . , 6)) is equal to or smaller than a threshold. If the feature amount (information amount Ei (i=1, . . . , 6)) is equal to or smaller than the threshold, the measurement data selection unit 104 determines that the position and orientation of the target object cannot be determined by a predetermined number of selected three-dimensional points, and additionally selects new three-dimensional points. More specifically, the measurement data selection unit 104 selects, from the sorted measurement data, measurement data whose flag F is FALSE, and associates it with the nearest plane. The measurement data selection unit 104 then determines whether the absolute value of the inner product of the eigenvector and coefficient vector is equal to or larger than a threshold (≧Th_dot), and if so, selects the measurement data. If the absolute value is smaller than the threshold (<Th_dot), the process returns again to step S405 without selecting measurement data. If the measurement data selection unit 104 selects measurement data, it calculates the information amount Ei again for each eigenvector EVi. That is, the sum of squares of the inner products of the coefficient vector of the selected measurement data and respective coefficient vectors is added to EVi.

After that, the processing in step S303 ends.

In step S304, the position and orientation calculation unit 105 calculates the position and orientation of the object using the measurement data selected in step S303. In this case, the approximate position and orientation input in step S301 are repetitively corrected to minimize the sum of squares of the three-dimensional distances in the three-dimensional space between planes and measurement points (predetermined number of three-dimensional points, and added three-dimensional points) in the model that are associated with each other. More specifically, Δsᵢ is calculated using equation (2) set up for each selected measurement data as simultaneous equations pertaining to the position and orientation correction value Δsᵢ (i=1, 2, . . . , 6). The position and orientation s is corrected based on the calculated Δsᵢ. Note that conversion of a three-dimensional position for the position and orientation is nonlinear conversion. After correcting s, the coefficients on the right-hand side and the values on the left-hand side both of equation (2) are calculated again to repetitively calculate and correct Δsᵢ.

As described above, according to the first embodiment, measurement data are selected based on their qualities to calculate the position and orientation. The position and orientation can be measured quickly with high accuracy.

### Second Embodiment

In the first embodiment, the position and orientation are calculated after selecting measurement data. To the contrary, the second embodiment will describe a case in which the position and orientation are sequentially updated every time measurement data is selected.

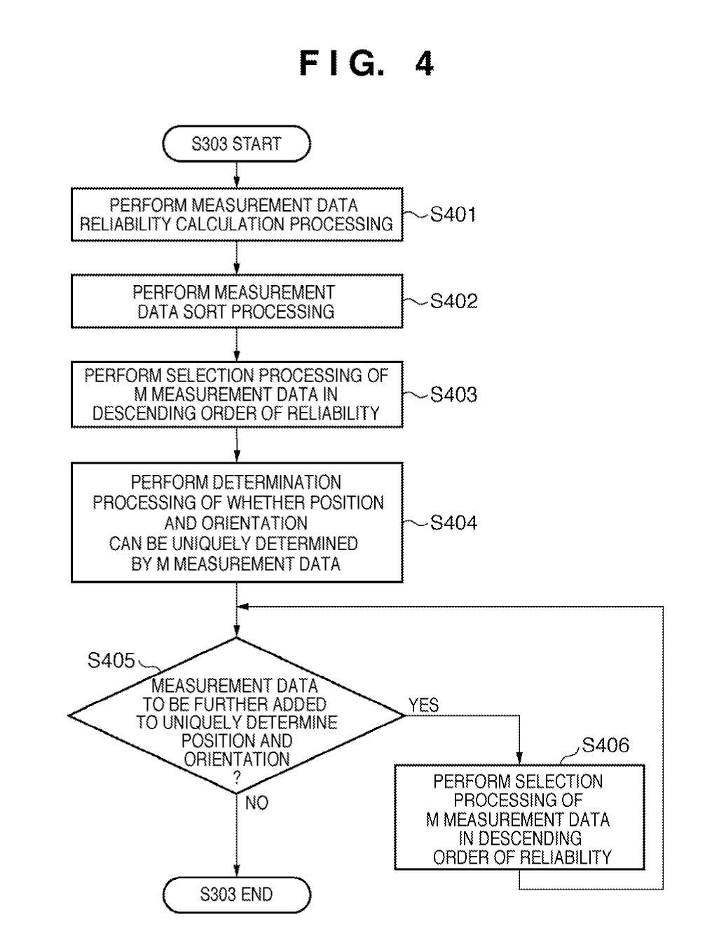

The arrangement of a position and orientation measurement apparatus 500 according to the second embodiment will be described with reference to FIG. 5. As shown in FIG. 5, the position and orientation measurement apparatus 500 includes a three-dimensional model save unit 501, approximate position and orientation input unit 502, measurement data input unit 503, measurement data selection unit 504, and position and orientation update unit 505. A three-dimensional data measurement unit 506 is connected to the position and orientation measurement apparatus 500. Each building unit of the position and orientation measurement apparatus 500 will be explained. The three-dimensional model save unit 501, approximate position and orientation input unit 502, measurement data input unit 503, and three-dimensional data measurement unit 506 are identical to the three-dimensional model save unit 101, approximate position and orientation input unit 102, measurement data input unit 103, and three-dimensional data measurement unit 106 in the first embodiment, and a description thereof will not be repeated.

The position and orientation update unit 505 extracts measurement data from measurement data (three-dimensional point cloud) input via the measurement data input unit 503, and updates the position and orientation based on the measurement data. The position and orientation update unit 505 repeats this processing.

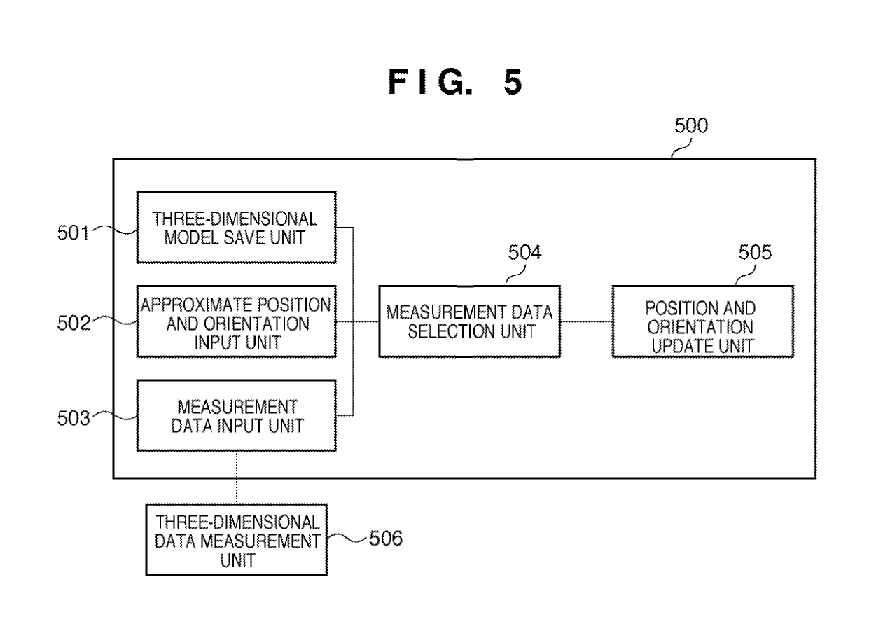

FIG. 6 is a flowchart showing a position and orientation measurement processing sequence according to the second embodiment. Processing in step S601 is identical to that in step S301 in the first embodiment. Processing in step S602 is identical to that in step S302 in the first embodiment. In step S603, the position and orientation update unit 505 calculates the position and orientation by repeating processing of selecting measurement data from measurement data input via the measurement data input unit 503 based on the quality of measurement data and the degree of contribution to position and orientation measurement, and updating the position and orientation.

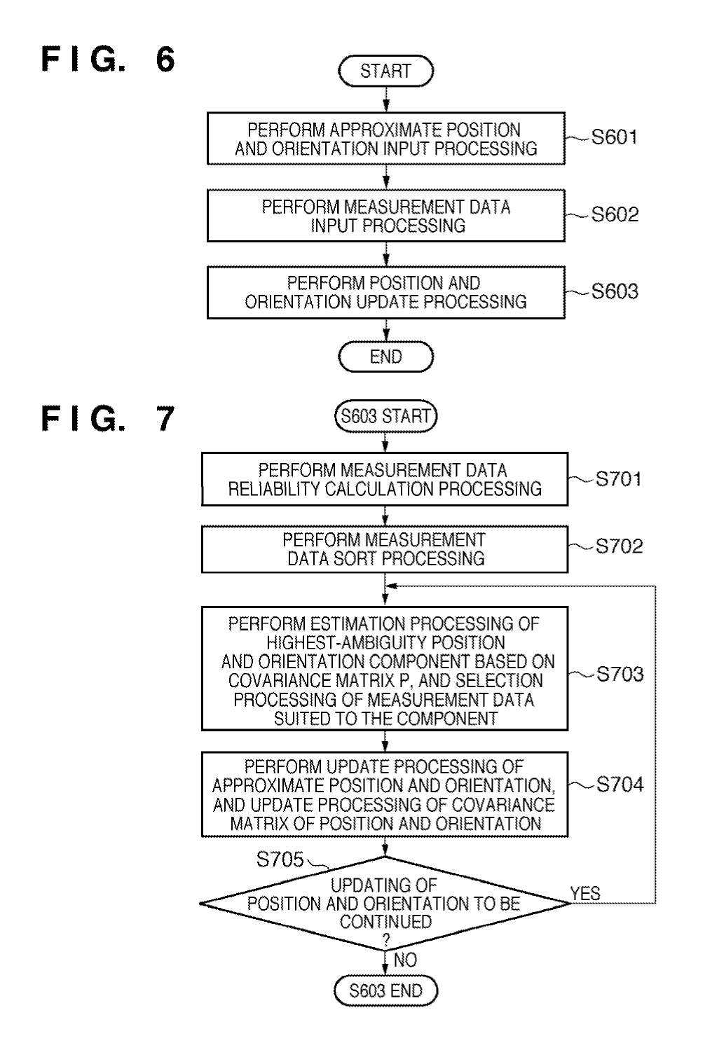

A detailed processing sequence of updating the position and orientation in step S603 will be explained with reference to FIG. 7.

Processing in step S701 is identical to that in step S401 in the first embodiment. In addition, the position and orientation update unit 505 receives a 6×6 covariance matrix P as an index indicating the ambiguity (approximate value reliability) of an approximate position and orientation (approximate value reliability input processing). The covariance matrix is a matrix having the variances of respective components of the position and orientation at diagonal elements and the covariances between components at off-diagonal elements. In the embodiment, the covariance matrix of an approximate position and orientation is input as a fixed value via an input unit (not shown), and given as a 6×6 matrix.

Even processing in step S702 is identical to that in step S402 in the first embodiment. In step S703, the measurement data selection unit 504 estimates highest-ambiguity position and orientation components based on the covariance matrix P of the current position and orientation, and selects measurement data suited to update the component.

First, to estimate a highest-ambiguity position and orientation component, the inverse matrix of the covariance matrix P undergoes eigenvalue decomposition, calculating six eigenvalues and corresponding eigenvectors EVi (i=1, . . . , 6) (eigenvector calculation processing). Within the range of linear approximation, the inverse matrix of the covariance matrix P is equivalent to the matrix J^{T}J in the first embodiment (see W. Hoff and T. Vincent, “Analysis of head pose accuracy in augmented reality,” IEEE Transactions on Visualization and Computer Graphics, vol. 6, no. 4, pp. 319-334, 2000.)

Then, the measurement data selection unit 504 selects an eigenvector Evi with a smallest eigenvalue as the highest-ambiguity position and orientation component, and selects measurement data having a coefficient vector closest to the eigenvector. The coefficient vector is obtained by aligning the partial differential coefficients of the signed distances between points and planes pertaining to the position and orientation. The coefficient vector corresponds to a row in the matrix on the left-hand side of equation (3). More specifically, the measurement data selection unit 504 selects, from measurement data sorted in step S702, measurement data whose flag F is FALSE, and associates it with the nearest plane. The measurement data selection unit 504 then changes the flag F of the selected measurement data to TRUE. Based on the obtained correspondence information, the measurement data selection unit 504 calculates the partial differential coefficients of the signed distances between points and planes pertaining to the position and orientation, obtaining the coefficient vector (coefficient vector calculation processing). If the absolute value of the inner product of the eigenvector and coefficient vector is equal to or larger than the threshold Th_dot, the position and orientation are updated in step S704.

In step S704, the position and orientation update unit 505 updates the approximate position and orientation and updates the covariance matrix of the position and orientation by using one measurement data selected in step S703 according to the SCAAT (Single Constraint At A Time) algorithm which adopts the principle of an extended Kalman filter (see G. Welch and G. Bishop, “SCAAT: incremental tracking with incomplete information,” Proc. 24th annual conference on Computer graphics and interactive techniques (SIGGRAPH '97), pp. 333-344, 1997). A general extended Kalman filter requires measurement data by a number by which all components of the position and orientation can be determined. However, the SCAAT algorithm can partially update the position and orientation using single measurement data.

After the updating, it is determined in step S705 whether to continue updating of the position and orientation. If the magnitude of each element in the covariance matrix updated in step S704 becomes equal to or smaller than a predetermined value or a predetermined calculation time has elapsed, the update processing ends (NO in step S705). If YES in step S705, the process returns to step S703.

As described above, according to the second embodiment, measurement data are selected based on both the quality of measurement data and the degree of contribution to position and orientation measurement, and the position and orientation are updated. By repeating this processing, the position and orientation can be measured quickly with high accuracy.

### Third Embodiment

The above-described embodiments assume that the vicinity of a measurement point is a locally flat plane and measurement can be performed stably when the plane and camera correctly face each other. The quality of measurement data is then calculated based on the angle between the normal vector of the flat plane and the view vector. However, the measurement data quality calculation method is not limited to this. For example, the measurement quality may be considered high for similar three-dimensional coordinates of a point near a measurement point on the object surface. In this case, the quality of measurement data is calculated based on variations of the three-dimensional positions of points around the measurement point on the distance image. More specifically, the three-dimensional coordinates of a plurality of points near a measurement point on a distance image are calculated. Then, the covariance matrix of the three-dimensional coordinates is obtained. A maximum eigenvalue upon eigenvalue decomposition of the covariance matrix is employed as the quality of measurement data.

### Fourth Embodiment

In the above embodiments, the position and orientation are measured by fitting a three-dimensional model for an object to a three-dimensional point cloud obtained by converting a distance image measured by a distance sensor. However, measurement data to which the present invention is applicable is not limited to the distance image (three-dimensional point cloud), and may be, for example, an image feature detected on a two-dimensional image. The image feature can be a feature point or edge. When an edge is used, the coefficient matrix is formed from partial differential coefficients obtained when the position and orientation function is given not by the signed distances between planes and points in a three-dimensional space but by those between lines and points on a three-dimensional image. When a feature point is used, the coefficient matrix is formed from partial differential coefficients obtained when the position and orientation function is given by the differences between coordinates on a two-dimensional image.

When an edge is used, the number of edges present at the periphery on a two-dimensional image can be employed as the quality of measurement data. More specifically, when many edges exist near an edge associated with a line segment in a given model, the association is highly likely to be erroneous, so the quality of measurement data is lowered. Alternatively, the size of an edge detection kernel may be used as the quality of measurement data. More specifically, edge detection is done using edge detection kernels of different sizes on a two-dimensional image. The edge position accuracy decreases for a larger kernel size upon detecting an associated edge, and the quality of measurement data is lowered.

When a feature point is used, the degree of matching between feature points may be used as the quality of measurement data. When a three-dimensional model is represented by a point cloud and each point stores peripheral luminance information as a patch, the quality of measurement data is determined based on the SSD indicating the sum of squares of the differences in luminance value between patches around a feature point on an image and patches on a model. For low degree of matching between luminance values, the quality of measurement data is lowered.

However, the measurement data quality calculation method is not limited to this, and any index is available as long as it can appropriately express the quality of measurement data.

According to the present invention, even when measurement data contain poor-quality one, the position and orientation of an object can be quickly measured with high accuracy from a small number of measurement data.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-166500 filed on Jul. 23, 2010, which is hereby incorporated by reference herein in its entirety.

1. A position and orientation measurement apparatus for measuring a position and orientation of a target object, comprising:
storage means for storing a three-dimensional model representing three-dimensional shape information of the target object;
obtaining means for obtaining a plurality of measurement data about the target object sensed by image sensing means;
reliability calculation means for calculating reliability for each of the measurement data;
selection means for selecting the measurement data by a predetermined number from the plurality of measurement data based on the reliability;
association means for associating planes forming the three-dimensional model with each of the measurement data selected by said selection means; and
decision means for deciding the position and orientation of the target object based on the result associated by said association means.

2. The apparatus according to claim 1, wherein the selection means selects the measurement data by a predetermined number in descending order of the reliability.

3. The apparatus according to claim 1 further comprising:
input means for inputting approximate values of a position and orientation of the target object;
wherein the association means associates planes forming the three-dimensional model with each of the predetermined number of three-dimensional points selected by said selection means by translating or rotating the three-dimensional model based on the approximate values input by said input means.

4. The apparatus according to claim 1, wherein the measurement data is distance information indicative of a distance from a predetermined position to each of the plurality of points on the target object.

5. The apparatus according to claim 4, wherein the obtaining means transforms the measurement data into each of the position information of the plurality of points.

6. The apparatus according to claim 5, wherein the decision means decides, as the position and orientation of the target object, a position and orientation which minimize a sum of squares of three-dimensional distances between the positions of the plurality of the points associated by said association means, and the planes forming the three-dimensional model.

7. The apparatus according to claim 1, wherein the reliability calculation means calculates, in the case that measurement points of the measurement data locally form a plain surface, the reliability based on an angle between a normal direction of the plain surface and an image sensing direction by the image sensing means

8. The apparatus according to claim 7, wherein said reliability calculation means calculates, as the reliability, an absolute value of an inner product of between a normalized normal vector for the normal direction and a normalized image sensing direction vector for the image sensing direction.

9. The apparatus according to claim 1, further comprising:
determination means for determining whether it is possible to decide the position and orientation of the target object uniquely by the predetermined number of the measurement data selected by the selection means,
wherein the selection means additionally selects non-selected measurement data from the plurality of the measurement data in the case that the determination means determines it is impossible to decide the position and orientation of the target object uniquely.

10. The apparatus according to claim 9, further comprising:
feature amount calculation means for calculating a feature amount indicating whether said decision means can decide a position and orientation of the target object that corresponds to eigenvectors, based on the eigenvectors and eigenvalues obtained by eigenvalue decomposition of a matrix expressed by a product of a transpose of a coefficient matrix which defines a positional relationship between the three-dimensional points and the planes forming the three-dimensional model, and the coefficient matrix,
wherein the determination means determines whether it is possible to decide the position and orientation of the target object uniquely, according to whether the feature amount is not larger than a threshold.

11. The apparatus according to claim 3 further comprising:
approximate value reliability input means for inputting an approximate value reliability indicative of reliability of the approximate values of the position and orientation of the target object input by the input means,
wherein the selection means selects measurement data from the plurality of the measurement data based on the reliability of the measurement data and the approximate value reliability.

12. The apparatus according to claim 11, wherein the approximate value reliability input means inputs, as a 6×6 matrix, the approximate value reliability;
the apparatus further comprising:
eigenvector calculation means for calculating six eigenvalues and six eigenvectors corresponding to the eigenvalues by eigenvalue decomposition of an inverse matrix of the matrix;
coefficient vector calculation means for calculating a coefficient vector which defines a positional relationship between a three-dimensional point corresponding to an eigenvector with a smallest eigenvalue out of the six eigenvalues and the six eigenvectors corresponding to the eigenvalues, and a plane forming the three-dimensional model;
judgment means for judging whether an absolute value of an inner product of the eigenvector and the coefficient vector is not smaller than a threshold; and
update means for updating the approximate values of the position and orientation when said judgment means judges that the absolute value of the inner product is not smaller than the threshold.

13. A position and orientation measurement method for measuring a position and orientation of a target object, comprising:
an obtaining step of obtaining a plurality of measurement data about the target object sensed in an image sensing means;
a reliability calculation step of calculating reliability for each of the measurement data;
a selection step of selecting the measurement data by a predetermined number from the plurality of measurement data based on the reliability;
an association step of associating planes forming a three-dimensional model with each of the measurement data selected in the selection step, based on the three-dimensional model which is stored in storage means and represents three-dimensional shape information; and
a decision step of deciding the position and orientation of the target object based on the result associated in the association step.

14. A computer-readable storage medium storing a computer program for causing a computer to execute a position and orientation measurement method defined in claim 13.
